(19) United States
(12) Patent Application Publication
(10) Pub. No.: US 2002/0045420 A1
(43) Pub. Date: Apr. 18, 2002

(54) Loading dock vehicle ventilation system

(76) Inventor: Daniel Taillon, Blainville (CA)

Correspondence Address: Daniel Taillon, 39 des Mesanges, Blainville, QC, J7C 1X6, CA

(21) Appl. No.: 09/975,982

(22) Filed: Oct. 15, 2001

Related U.S. Application Data
(60) Provisional application No. 60/239,868, filed on Oct. 13, 2000.

(51) Int. Cl. B60H 1/00

(52) U.S. Cl. 454/119

(57) ABSTRACT

A loading dock vehicle ventilation system for ventilating vehicles such as semi-trailer or the like docking at conventional loading docks. The ventilation system includes a blower component and an outlet duct in fluid communication with the blower outlet. The outlet duct defines a discharge end positioned adjacent the loading dock door allowing the discharge end to discharge air emanating from the loading dock area into though the loading dock door and into the vehicle. In one embodiment of the invention at least two outlet ducts provided with corresponding outlet valves are connected to a single blower component for selectively ventilating vehicles docked at adjacent docking doors. Air inlet ducts provided with inlet valves are strategically positioned so as to allow for selective intake of air having specific properties.

### FIELD OF THE INVENTION

The present invention relates to the general field of loading dock accessories and is particularly concerned with a loading dock vehicle ventilation system for ventilating vehicles such as semi-trailer or the like docking at conventional loading docks.

### BACKGROUND OF THE INVENTION

In most regions of the globe efficient distribution systems for raw materials and finished goods is of the outmost importance. Various types of vehicles such as trucks are used extensively as essential components of such distribution systems. There are several different forms of truck trailers and truck beds which have differing designs primarily for purposes of carrying loads of different loading and/or hauling requirements.

Perhaps the simplest type of truck trailer or cargo area is the flat bed, which merely provides a floor area with no roof or sidewalls. Flat bed trucks and trailers are primarily used to haul sizable loads which will not be affected by adverse weather conditions, particularly loads that can be more easily loaded with a crane or fork lift truck, such as large pieces of machinery, logs, steel mill products like steel coils, steel plates, steel beams, etc., and other comparable loads. The nature of such loads usually requires that they be tied down to the flat bed floor with cables and chains.

There are many loads, however, which require the use of dry vans, i.e. closed truck trailers or cargo areas for the purposes of protecting the cargo from adverse weather conditions which may even include refrigeration of perishable goods. Dry vans are perhaps the most common of all truck trailers and cargo areas, and are used to haul all kinds of goods such as home furnishings, clothing, food products and many other products that are not suitable for loading on a flat bed truck. Even products that may not be adversely affected by varying weather conditions may be small enough that they must be hauled in dry vans for purposes of keeping the cargo within a lockable confinement for sake keeping, or simply to confine the cargo to a closure so that it does not need to be tied down or otherwise confined to keep it from falling from the truck bed.

Dry vans typically provided with doors at the rear end of the trailer or cargo area through which the dry van is loaded and unloaded. One very common type of dry van is the so-called “tractor-trailer combination” or “semi” as it is often called. The trailer of the tractor-trailer combination will henceforth be referred to as a “trailer” or “semi-trailer”.

A tractor-trailer generally consists of a tractor that provides the locomotive force necessary to haul a detachable multiple-axle trailer component that supports the cargo to be transported. The multiple-axle trailer component typically consists of a trailer chassis or under frame with a cargo-carrying bed mounted thereon, and an appropriate number of axles and wheels mounted to the chassis to support and distribute the weight of the cargo upon the road. The tractor and trailer are detachably connectable through conventional pivotable couplings, which are typically centered above the rear axle of the tractor, and which facilitate the turning of such multi-axle trucking rigs.

When they are used as part of distribution networks, vehicles such as semi-trailers must be loaded and unloaded at various locations. Some of these locations including most warehouses, manufacturing facilities and large retail stores are provided with specially allocated areas commonly referred to as loading docks or loading bays that provide a relatively standardized environment for loading and unloading the trucks or other vehicles. Truck trailers are typically backed up to loading docks at facilities or terminals which house cargo for loading cargo on the trailers or for receiving cargo being unloaded from the trailers. The cargo is ordinarily loaded and unloaded by manual labor alone, or with the assistance of a fork lift tractor

Loading docks or bays typically include a raised platform and a dock opening positioned above the raised platform. The dock opening is formed by a dock wall having two vertical side portions extending upwardly from the platform and a horizontal upper portion connecting the top of the side portions. Vehicles typically back towards the dock opening until the back of the vehicle is abutting against the platform. The platform sometimes includes a dock-leveler that provides a ramp between the platform and bed of the vehicle to facilitate loading and unloading thereof, for example when the operation is performed with the help of a forklift.

Many loading-unloading docks include a dock-seal that provides a seal between the dock wall and the back or body of the trailer. The dock-seals are provided to limit air exchange between outside and inside the building. Indeed, despite the relatively large open area formed by the openings of the loading docks, it is often desirable to strive towards maintaining a uniform temperature in the building and also to try avoiding draughts.

The door seal elements thus ensure that the interior of the vehicle is connected as tightly as possible to the storage room without the possibility of the external air penetrating. Expensive external ramps and canopies can be economized by this means. The door seal elements also permit the freight to be moved into the building or vice versa without it being exposed to the weather. The seals thus afford shelter for both worker and goods during the loading and unloading of cargo bodies from trucks and trailers. Normally these structures have a perimetric form including side members and a top member extending across the top of the doorway between the two side members.

The prior art is replete with various types of door seal configurations testifying to the efforts deployed for controlling the temperature and environmental conditions of the loading dock areas. However, the prior art fails to propose a suitable method or structure for controlling the temperature and environmental conditions prevailing inside the cargo vehicles while the latter are docked at conventional loading docks. Since the trailer or cargo vehicle is usually enclosed except for its open rear end leading into the facility or terminal, air circulation in the vehicle interior is generally inadequate, requiring that air be supplied from an external source for the comfort of the dock personnel. Supplying air to the interior of the trailer is especially important in the summer months when, for example, the sunlight hitting the trailer causes the temperature within the trailer to rise.

It is also desirable to ventilate the interior of trailers or other docked vehicles for numerous other reasons. Some of the most obvious reasons include avoiding condensation, ventilating the stale air and meeting work place standards such as standards imposed regarding the rate of air volume changes. Ventilating the interior of trailers or other docked vehicles could also help in maintaining the goods and the personnel at a suitable predetermined temperature without the help of temperature control devices related to the vehicle. For example, refrigerated air from a refrigerated dock could be ventilated in a refrigerated truck, eliminating the need to keep the refrigeration system of the refrigerated truck working.

In the past, fans on various stands have been used by placing them on the facility floor and aiming the same toward the truck trailer for supplying air into its interior. However, these fans tend to get in the way of loading and unloading and, thus, making the loading and unloading procedure more difficult, time-consuming, and burdensome. These concerns, which were ever so present in the past, have become even more important since regulations have been relaxed to permit longer trailers. Accordingly, there exists a need for a loading dock vehicle ventilating system.

### SUMMARY OF THE INVENTION

In accordance with an embodiment of the invention, there is provided a loading dock vehicle ventilation system for ventilating a vehicle storage compartment part of a vehicle docking at loading dock, the vehicle storage compartment defining a vehicle platform, a pair of vehicle side walls extending from the vehicle platform, a vehicle front wall also extending from the vehicle platform and a vehicle rear opening positioned substantially opposite the vehicle front wall and leading into the vehicle storage compartment, the loading dock defining a dock platform having a docking edge, the loading dock also defining a dock ceiling and a dock wall extending from the dock platform adjacent the docking edge to the dock ceiling, the dock wall separating the interior environment of the loading dock from the exterior environment, the interior environment defining a dock upper section located substantially adjacent the dock ceiling and a dock lower section located substantially adjacent the dock platform, the dock wall being provided with a dock aperture extending therethrough, the dock aperture defining a pair of opposed dock aperture side peripheral edges and a dock aperture upper peripheral edge, the interior environment of the loading dock being filled with a volume of loading dock air, the ventilation system comprising: a blower component defining a blower inlet and a blower outlet for drawing a ventilating air volume of the volume of loading dock air through the blower inlet and blowing the ventilating air volume through the blower outlet; an outlet duct in fluid communication with the blower outlet, the outlet duct defining a discharge end, the outlet duct being configured, sized and positioned so that the discharge end is positioned adjacent the dock aperture allowing the discharge end to discharge the ventilating air volume though the dock aperture.

Preferably, the ventilating system includes a first pair of outlet ducts and a second pair of outlet ducts, the first and second pairs of outlet ducts being both in fluid communication with the blower outlet and respectively defining first and second pairs of outlet ends, the first and second pairs of outlet ducts being respectively configured, sized and positioned so that their respective first and second pairs of outlet ends are spaced in laterally opposite directions relative to the blower component, the ventilating system being further provided with a directing means mounted on the ventilating means for selectively directing the flow of the ventilating air volume either towards both outlet ends part of either one of the first or second pairs of outlet ends or towards a single outlet end part of both pairs of outlet ends; whereby the directing means allows for the discharge of the ventilating air volume either though a single one of the first or second dock apertures using two outlet ends or for the discharge of the ventilating air volume through both the first and second dock apertures using a single one of the outlet ends in each one of the first and second dock apertures.

Conveniently, the ventilating system includes a first inlet duct and a second inlet duct, the first and second inlet ducts being both in fluid communication with the blower inlet, the first and second inlet ducts respectively defining first and second inlet ends, the first and second inlet ducts being respectively provided with a first and a second inlet valve for regulating the flow of the ventilating air volume conveyed respectively by the first and second inlet ducts, the first inlet duct being configured, sized and positioned so that the first inlet end is positioned adjacent the dock upper section, the second inlet duct being configured, sized and positioned so that the second inlet end is positioned adjacent the dock lower section.

The present invention also relates to the combination of the loading dock as hereinafter disclosed with the ventilation system as hereinafter disclosed.

In accordance with the present invention, there is further provided a method for ventilating a vehicle storage compartment part of a vehicle docking at loading dock, the vehicle storage compartment defining a vehicle platform, a pair of vehicle sidewalls extending from the vehicle platform, a vehicle front wall also extending from the vehicle platform and a vehicle rear opening positioned substantially opposite the vehicle front wall and leading into the vehicle storage compartment, the loading dock defining a dock platform having a docking edge and a dock wall extending from the dock platform adjacent the docking edge, the dock wall separating the interior environment of the loading dock from the exterior environment, the dock wall being provided with a dock aperture extending therethrough, the interior environment of the loading dock being filled with a volume of loading dock air, the method comprising the step of: drawing a ventilating air volume of the volume of loading dock air and blowing the ventilating air volume through the dock wall and through the vehicle rear opening when the vehicle is docked at the loading dock so as to discharge the ventilating air volume into the vehicle storage compartment.

Preferably, the ventilating air volume is discharged into the vehicle storage compartment as a jet of air aimed towards the vehicle front wall, the jet of air being calibrated so as to expel stagnant air from within the vehicle storage compartment.

Advantages of the present invention include that the proposed ventilation system provides a means by which air can be aimed toward and provided in a truck trailer backed up to a loading dock facility. The proposed ventilation system is capable of being situated so as to effectively ventilate the interior of the vehicle without interfering or being in the way of both the working personnel and for adjacent structures such as loading dock doors or the like.

The proposed ventilation system allows for continuous renewal of air according to a predetermined air renewal time frame that can be customized depending on the type of trailers being used. Furthermore, the ventilation system is provided with a built-in means for economically modulating the temperature of the ventilated air.

The proposed system is configured so as to be able to ventilate a pair of substantially adjacent trailers with air originating from a single pressurizing unit thus providing a cost efficient solution. Furthermore, the ventilation system is provided with a built-in means for allowing customization of the flow of air to either a single or double unit configuration.

Still further, the proposed system is configured so as to provide a jet-type air stream for suitably providing a customized laminar and/or turbulent flow of air inside the trailer body forcing air renewal therein. Still further, the proposed ventilation system is provided with an optional built-in filtration system.

The proposed ventilation system is further designed so as to be easily and readily installed in most conventional truck docks without requiring special tooling or manual dexterity and without major modifications to the dock infrastructure.

Still further, the proposed ventilation system is adapted to conform to conventional forms of manufacturing, to be of simple construction and easy to use so as to provide a ventilation system that will be economically feasible, long lasting and relatively trouble free in operation.

### BRIEF DESCRIPTION OF THE DRAWINGS

An embodiment of the present invention will now be disclosed, by way of example, in reference to the following drawings in which:

FIG. 1: in a partial perspective view with sections taken out, illustrates a conventional semi-trailer type vehicle parked adjacent a conventional loading dock, the loading dock being provided with a loading dock ventilation system in accordance with an embodiment of the present invention.

FIG. 2: in a perspective view with sections taken out, illustrates a loading dock ventilation system in accordance with an embodiment of the present invention mounted in a loading dock between a pair of adjacent loading dock apertures.

FIG. 3: in a partial perspective view with sections taken out, illustrates a loading dock ventilation system in accordance with an embodiment of the present invention mounted between adjacent loading dock apertures, one of the loading dock apertures being shown in an open configuration while the other is shown in a closed configuration.

FIG. 4: in a partial perspective view with sections taken out, illustrates some of the components of the blower unit and of the filtering unit both part of the loading dock ventilation system shown in FIGS. 1 through 3.

FIG. 5: in a partial perspective view with sections taken out, illustrates part of the blower unit shown in FIG. 4 including part of its driving components.

FIG. 6: in a partial perspective view with sections taken out, illustrates a section of an outlet nozzle part of the ventilation system shown in FIGS. 1 through 5.

FIG. 7: in a partial perspective view with sections taken out, illustrates some of the flow controlling means part of the ventilation system shown in FIGS. 1 through 6.

FIG. 8: in a partial perspective view with sections taken out, illustrates a conventional semi-trailer type vehicle parked adjacent a loading dock, the loading dock being provided with a loading dock ventilation system in accordance with an alternative embodiment of the present invention.

FIG. 9: in a perspective view with sections taken out, illustrates a loading dock ventilation system in accordance with an alternative embodiment of the present invention mounted in a loading dock between a pair of adjacent loading dock apertures.

FIG. 10: in a partial perspective view with sections taken out, illustrates a loading dock ventilation system in accordance with an alternative embodiment of the present invention

### DETAILED DESCRIPTION

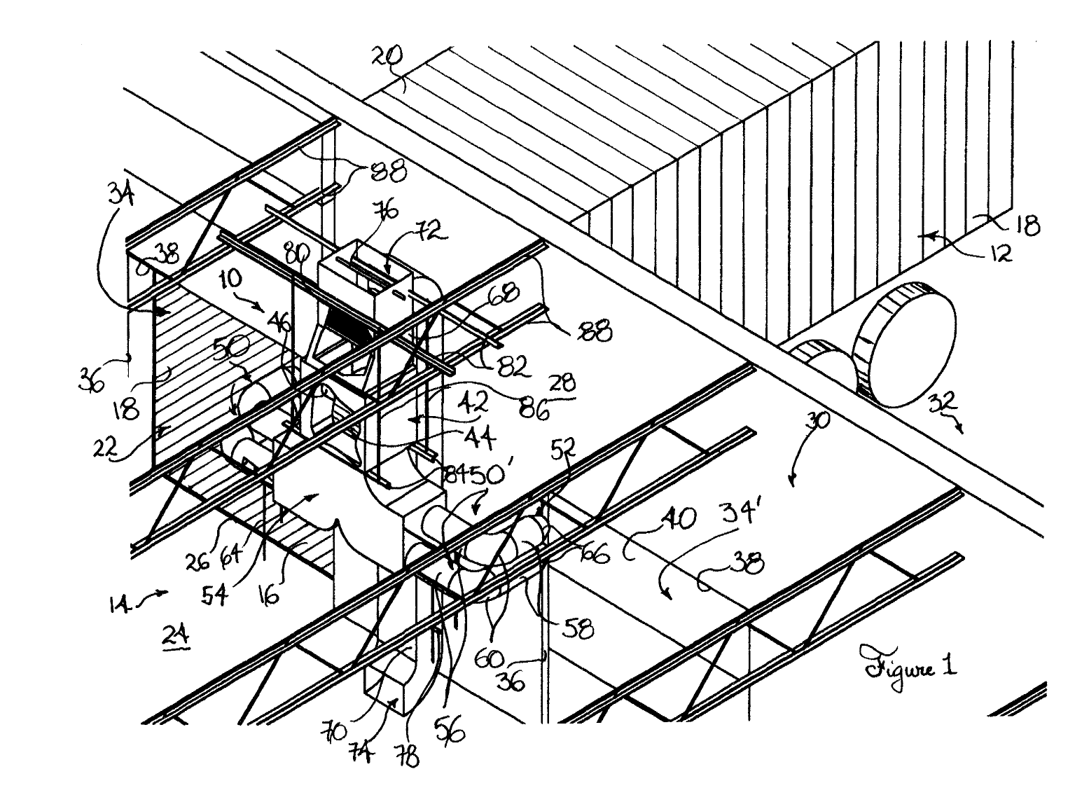

Referring to FIG. 1, there is shown a loading dock ventilation system 10 in accordance with an embodiment of the present invention. The ventilation system 10 is designed for ventilating a vehicle storage compartment 12 such as a trailer or semi-trailer part of a vehicle such as a trailer-truck docking at loading dock 14. For the most part, the following description and the Figures are directed to tractor-trailer combinations though the invention may be used with other types of trucks and even by other types of vehicles such as railway carts or the like without departing from the scope of the present invention.

The vehicle storage compartment 12 typically defines a vehicle platform 16, a pair of vehicle sidewalls 18 extending from the vehicle platform 16, a vehicle front wall (not shown) also extending from the vehicle platform 16, a vehicle roof 20 and a vehicle rear opening 22 positioned substantially opposite the vehicle front wall and leading into the vehicle storage compartment 12.

The loading dock 14 defines a dock platform 24 having a docking edge 26. The loading dock 14 also defines a dock ceiling (only a portion of which is shown) and a dock wall 28 extending from the dock platform 24 adjacent the docking edge 26 to the dock ceiling. The dock wall 28 separates the interior environment 30 of the loading dock from the exterior environment 32. In turn, the interior environment 30 defines a dock upper section located substantially adjacent the dock ceiling and a dock lower section located substantially adjacent the dock platform 24. The interior environment 30 of the loading dock 14 is filled with a volume of loading dock air (not shown).

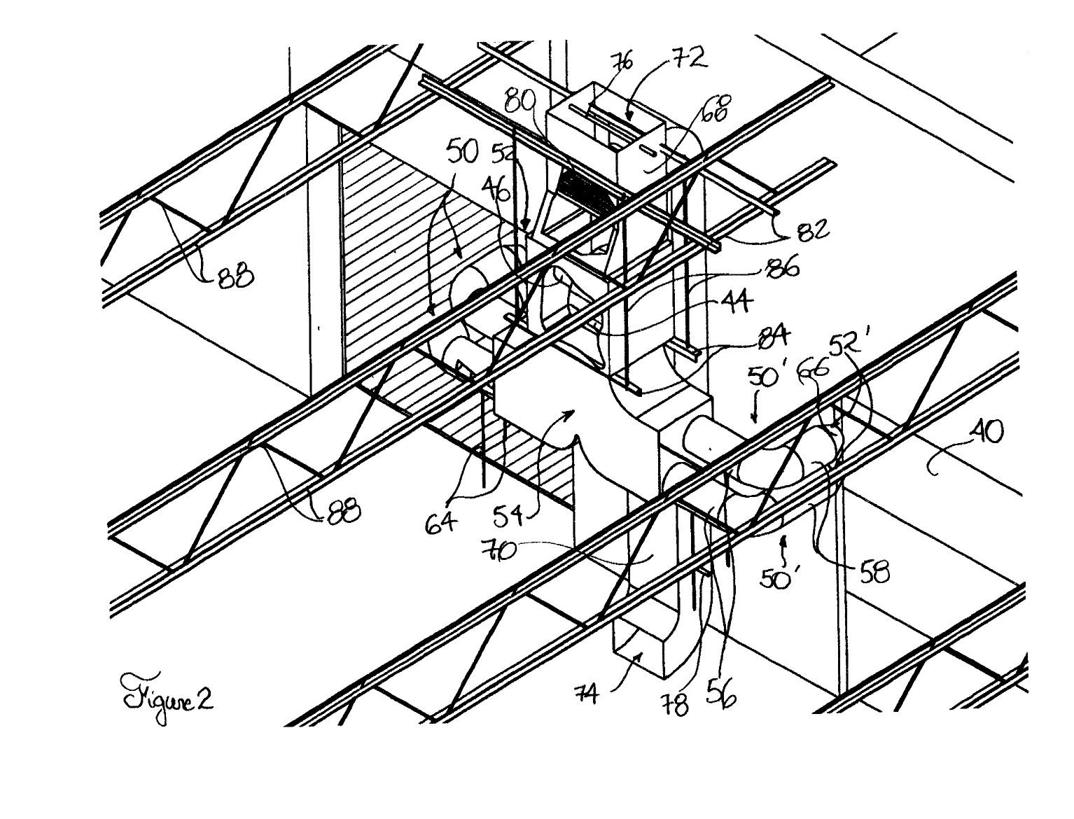

The dock wall 28 is provided with at least one and typically two adjacent dock apertures 34 extending therethrough. Each dock aperture 34 defines a pair of opposed dock aperture side peripheral edges 36 and a dock aperture upper peripheral edge 38. Each dock aperture 34 is typically provided with a corresponding dock aperture door 40, one of which is shown in an open position while the other is shown in a closed configuration in both FIGS. 1 and 2. Although the ventilation system 10 is shown throughout the figures as being used in a specific environment, it should be understood that the ventilation system 10 could be used in other settings without departing from the scope of the present invention.

The ventilation system 10 includes a blower component 42 defining a blower inlet and a blower outlet. The blower component 42 is provided for drawing a ventilating air volume of the volume of loading dock air through the blower inlet and blowing the ventilating air volume through the blower outlet in a conventional manner. The blower component 42 is illustrated throughout the Figures as being of the centrifugal-type including a cylindrical fan component 44 having radial fan blades and being mechanically coupled to a driving motor 46. It should however be understood that other types of blower could be used without departing from the scope of the present invention.

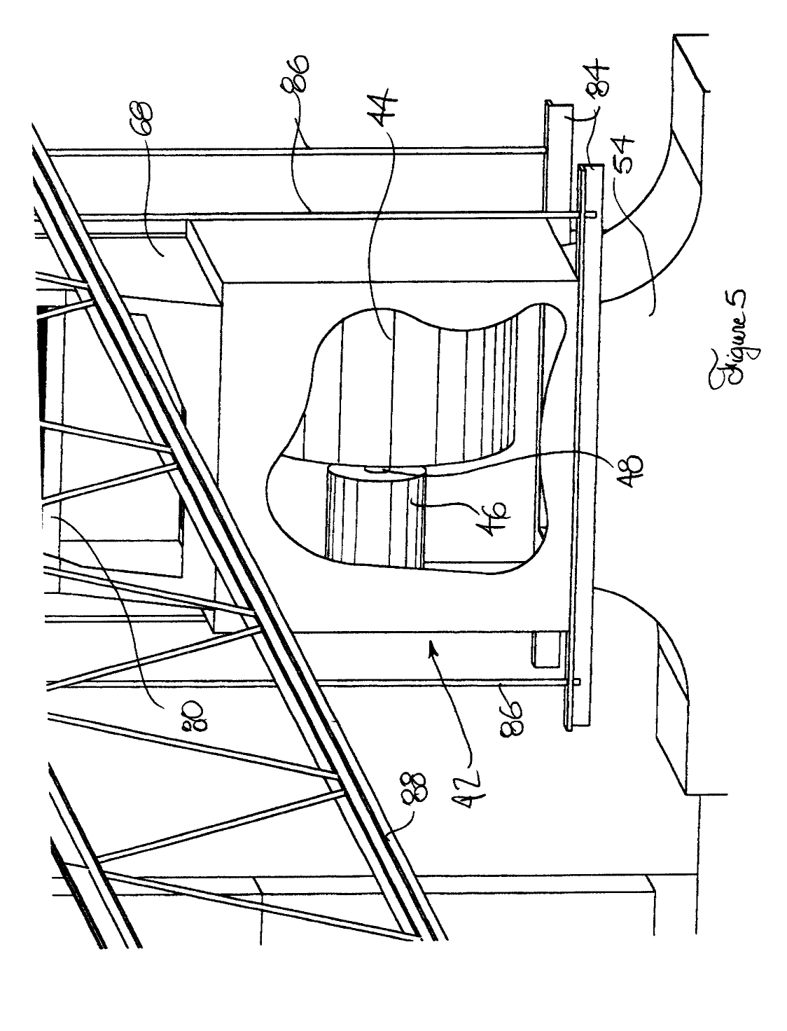

Also, FIG. 5 illustrates the fan component 44 directly mechanically coupled to the driving motor 46 by a driving shaft 48. Although this direct type of coupling could be used in order to reduce mechanical losses and thus improve overall efficiency, it should be understood that other types of mechanical coupling components such as gears, belts or the like could be used without from the scope of the present invention. Preferably, the driving motor 46 is a variable speed type motor so as to allow for control over the rotational speed of the fan component 44.

The ventilation system 10 also includes at least one and preferably four outlet ducts 50. Each outlet duct 50 is in fluid communication with the blower outlet. Each outlet duct 50 defines a corresponding discharge end 52. Each outlet duct 50 is configured, sized and positioned so that the corresponding discharge end 52 is positioned adjacent a corresponding dock aperture 34 allowing the discharge end 52 to discharge the ventilating air volume though the dock aperture 34 and into the vehicle storage compartment 12.

Preferably, each outlet duct 50 is configured, sized and positioned so that the corresponding discharge end 52 is positioned inwardly relative to the dock wall 28 and in a relatively proximal relationship relative to a corner portion of the dock aperture 34. Typically, each discharge end 52 is position adjacent the corner portion of a dock aperture 34 defined by the interception of one of the dock aperture side peripheral edges 36 with the dock aperture upper peripheral edge 38. Preferably, each discharge end 52 is positioned so as not to interfere with the movements of a proximal dock aperture door 40 and so as not to interfere with the work of workers potentially using fork-lifts or other equipment for loading or unloading goods.

Although the ventilating system 10 could be provided with a single outlet duct 50, in situation such as illustrated in FIGS. 1 and 2 wherein the loading dock 14 defines a pair of substantially adjacent dock apertures 34, 34′ it may prove to be cost efficient to use a single blower component 42 for ventilating through the adjacent dock apertures 34, 34′. In such situations, the blower component 42 is typically positioned intermediate the adjacent dock apertures 34, 34′ and two or preferably four strategically positioned outlet ducts 50 are used. The four outlet ducts 50 are preferably grouped into a first pair of outlet ducts 50 and a second pair of outlet ducts 50′. The first and second pairs of outlet ducts 50, 50′ are both in fluid communication with the blower outlet.

The first and second pairs of outlet ducts 50, 50′ respectively define first and second pairs of outlet ends 52, 52′. The first and second pairs of outlet ducts 50, 50′ are respectively configured, sized and positioned so that their respective first and second pairs of outlet ends 52, 52′ are spaced in laterally opposite directions relative to the blower component 42. The lateral spacing relative to the blower component 42 allows for positioning of the discharge ends 52 adjacent corresponding dock apertures 34, 34′.

When four outlet duct 50 are used, the ventilating system 10 is typically further provided with a directing means mounted on the ventilating means for selectively directing the flow of the ventilating air volume either towards both outlet ends part of either one of the first or second pairs of outlet ends 52, 52′ or towards a single outlet end part of both pairs of outlet ends 52, 52′. The directing means thus allows for the discharge of the ventilating air volume according to either a first or a second discharge pattern.

When the first discharge pattern is used, the ventilating air volume is discharge through a single one of the first or second dock apertures 34 using two corresponding outlet ends 52 or 52′. This first discharge pattern is used for example when only one dock aperture door 40 is open. Since all of the ventilating air volume is discharge in one vehicle storage compartment 12 the use of two outlet ducts discharging into this vehicle storage compartment 12 increases the ventilating efficiency. Alternatively, when the second discharge pattern is used, the directing means allows for the discharge of the ventilating air volume through both the first and second dock apertures 34, 34′ using only one of the outlet ends 52, 52′ in each one of the first and second dock apertures 34, 34′.

The ventilating system 10 typically further includes a generally inverted “Y”-shaped splitting manifold 54 in fluid communication with the blower outlet. Also, typically, each outlet duct 50 has a substantially “L”-shaped configurations defining an outlet duct spacing segment 56 extending laterally from the splitting manifold 54. The spacing segment 56 bends at an elbow 60 into a directing segment 58 extending substantially perpendicularly from the spacing segment 56 in a direction leading substantially towards a dock aperture 34.

Preferably, each outlet duct 50 is provided with an outlet duct valve for regulating the flow of the ventilating air volume conveyed by the outlet duct 50. When each outlet duct 50 is provided with an outlet duct valve the outlet duct valve act as directing means.

Other directing means such as baffles positioned within the manifold could be used without departing from the scope of the invention.

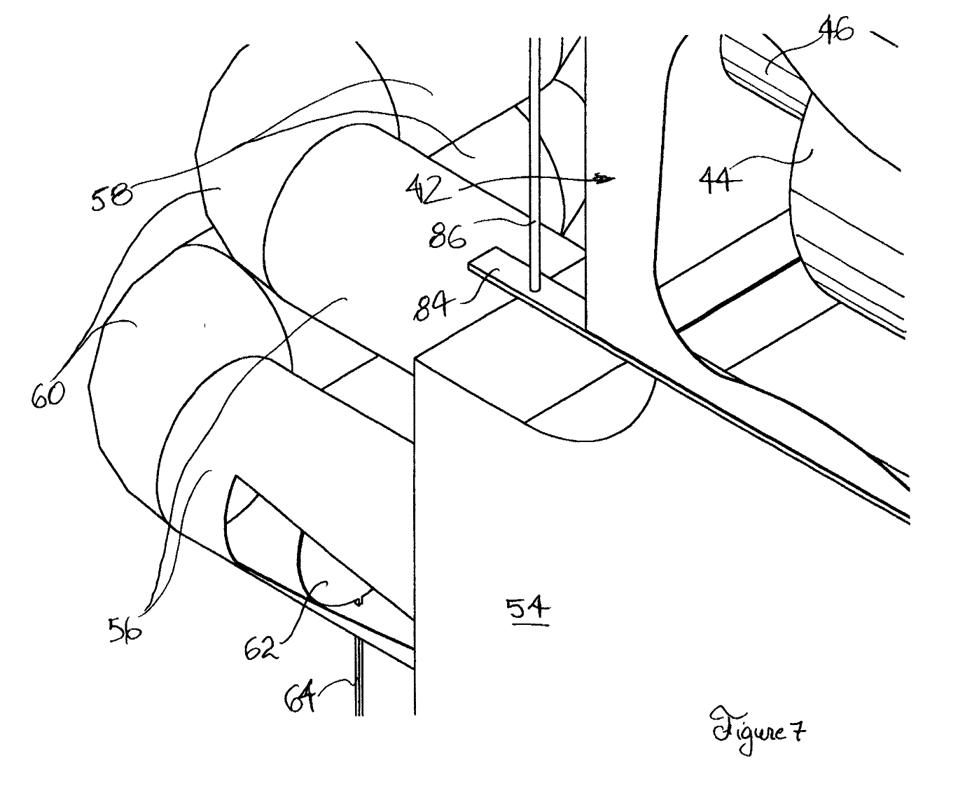

As shown more specifically in FIG. 7, the outlet valve preferably takes the form of an outlet valve plate 62 pivotally mounted within the outlet ducts 50. The outlet valve plate 60 is preferably mechanically coupled to an outlet valve handle 64. The valve handle 64 typically extends towards the dock platform 24 in order to allow an intended user to easily and ergonomically manipulate the outlet valve plates 62 while standing on the dock platform 24. It should be understood that other valve components and suitable valve actuating mechanisms could be used without departing from the scope of the invention.

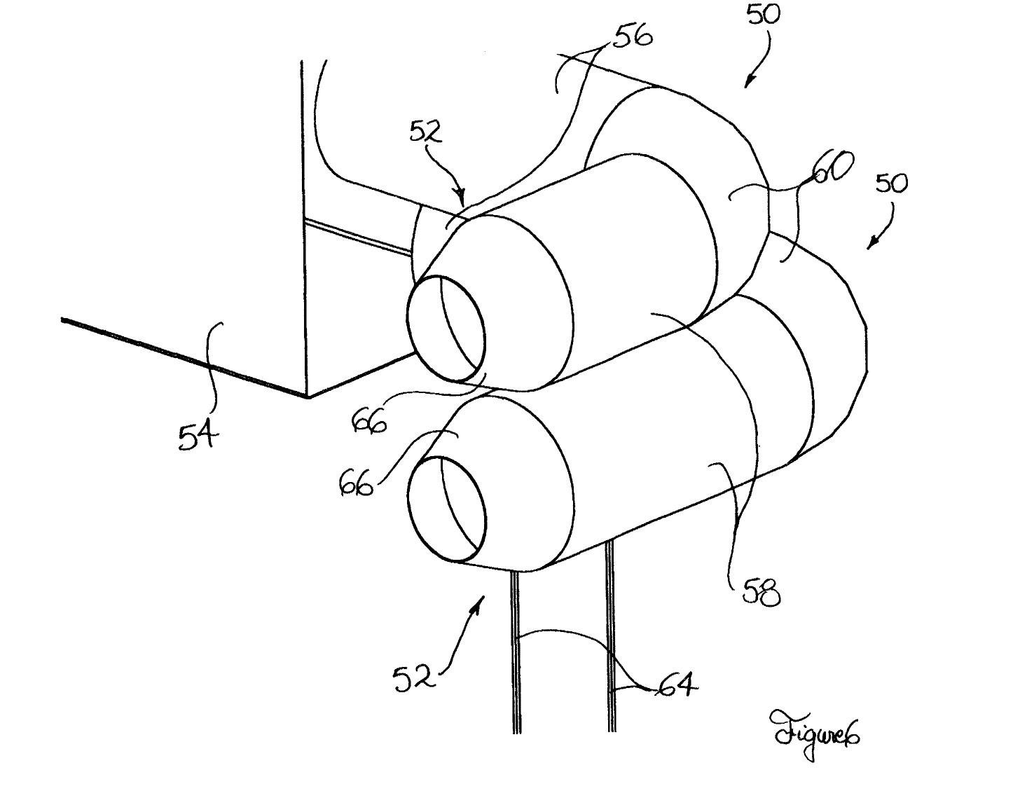

As illustrated more specifically in FIG. 6, each discharge end 52 is preferably provided with a discharge nozzle 66 for allowing the ventilating air volume to be discharged in the form of a ventilating jet of air projected out of the dock aperture 34. The discharge nozzle 66 typically has a generally frustro-conical configuration. Typically, although by no means exclusively, the internal diameter of the discharge nozzle 66 tapers by a value substantially in the range of 20% over the length of the discharge nozzle 66.

As is well known, the reduction in flow area related to the generally frustro-conical configuration of the discharge nozzle 66 creates an acceleration effect that provides the jet-like flow pattern. In turn, this jet-like flow pattern which can be either of the laminar or the turbulent type is specifically adapted to allow the air emanating from the ventilation system 10 to penetrate fully within the vehicle storage compartment 12 and to travel towards the vehicle front wall. The jet of air penetrating the vehicle storage compartment 12 towards the vehicle front wall, in turn, allows for circulation of the air contained within the vehicle storage compartment 12 since the pressure created by the velocity of the air flowing thereinto pushes the existing stale air along the surfaces of the container towards the vehicle rear opening.

The ventilating system 10 preferably further comprises at least one inlet duct in fluid communication with the blower inlet. Preferably, the ventilating system 10 includes a first inlet duct 68 and a second inlet duct 70, the first and second inlet ducts 68, 70 being both in fluid communication with the blower inlet.

The first and second inlet ducts 68, 70 respectively define first and second inlet ends 72, 74. The first inlet duct 68 is preferably configured, sized and positioned so that the first inlet end 72 is positioned adjacent the dock upper section and thus adjacent the dock ceiling. Substantially symmetrically, the second inlet duct 70 is preferably configured, sized and positioned so that the second inlet end 74 is positioned adjacent the dock lower section and thus adjacent the dock platform 24.

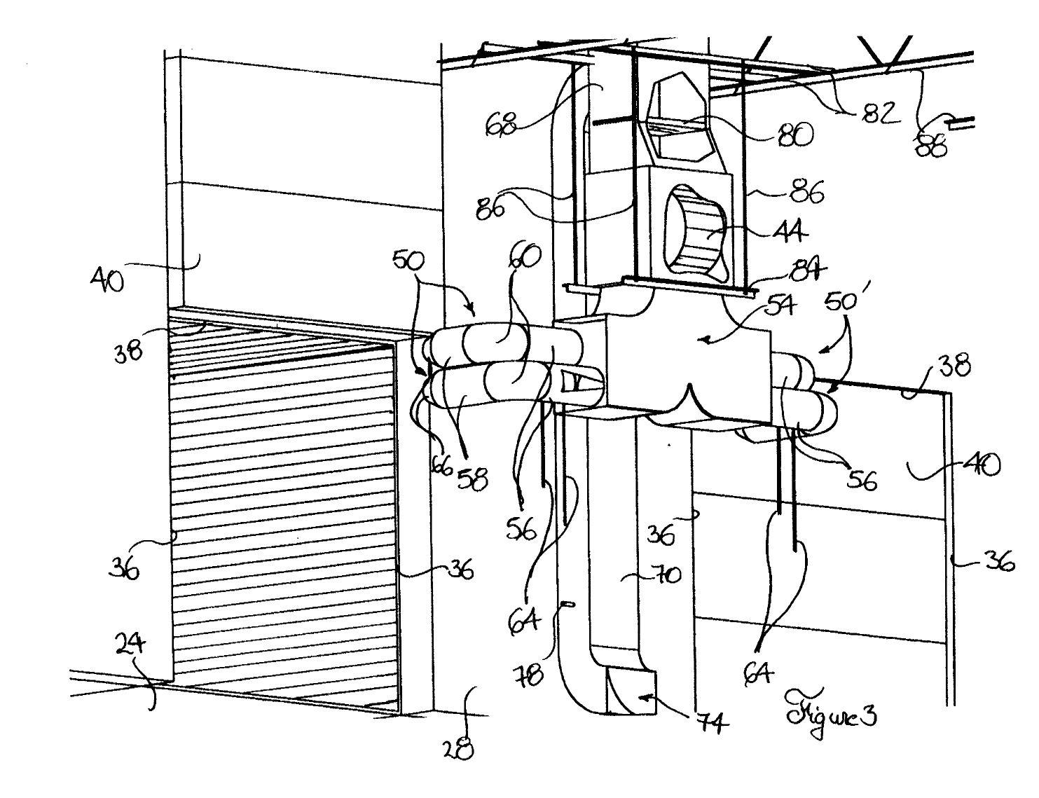

As illustrated more specifically in FIGS. 1 through 3, the second inlet duct 70 typically extends from a position located underneath the blower component 42 to a position located above the blower component 42 where it pneumatically connects with the first inlet duct 68. Typically, the second inlet duct 70 is provided with elbow sections adjacent its upper and lower ends allowing the second inlet end 74 to extend in a substantially vertical geometrical plane and the second inlet duct to extend rearwardly relative to the blower component 42. Also, preferably, the second inlet duct 70 extends in a generally parallel and proximate relationship relative to the blower component 42 and to the first inlet duct 68 thus allowing the ventilation device 10 to form a substantially compact structure.

The first and second inlet ducts 68, 70 are preferably respectively provided with a first and a second inlet valve schematically respectively represented by first and second rods 76, 78 for regulating the flow of the ventilating air volume conveyed respectively by the first and second inlet ducts 68, 70. The first and second inlet valve may take the form of inlet valve plates actuated by corresponding valve plate rods or any other suitable form without departing from the scope of the present invention.

As is well known, warmth reduces the density of air. Warm air thus has a tendency to rise and stagnate along the ceiling of rooms, while colder air remains adjacent the floor. The presence of first and second inlet ends 72, 74 respectively positioned adjacent the dock upper section and the dock lower section allows to take advantage of the air stratification. Typically, when the ventilation system 10 is used in the context of a non-refrigerated environment, the first inlet valve is closed during the warmer season while the second inlet valve is open, thus preventing heated air from being blown into the already warm vehicle compartment. Conversely, the first inlet valve is typically closed, while the second inlet valve is opened during the colder season allowing for the warmer air to be distributed inside the vehicle compartment 12 and reducing the need for keeping the warming system of the docked vehicle operational.

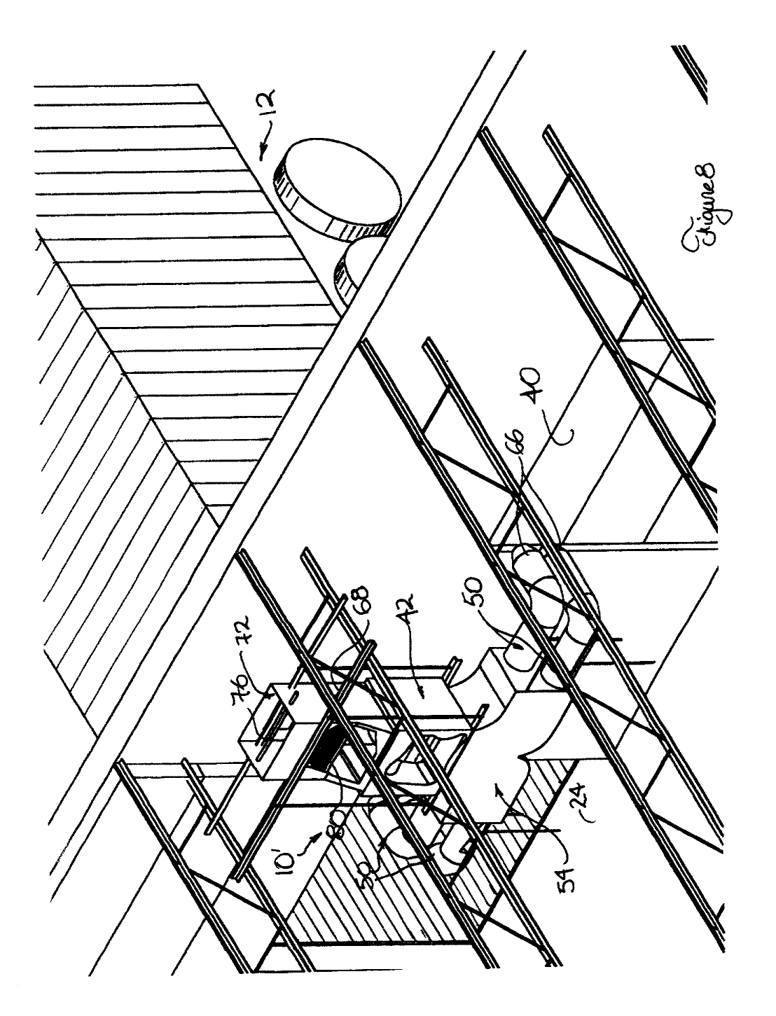

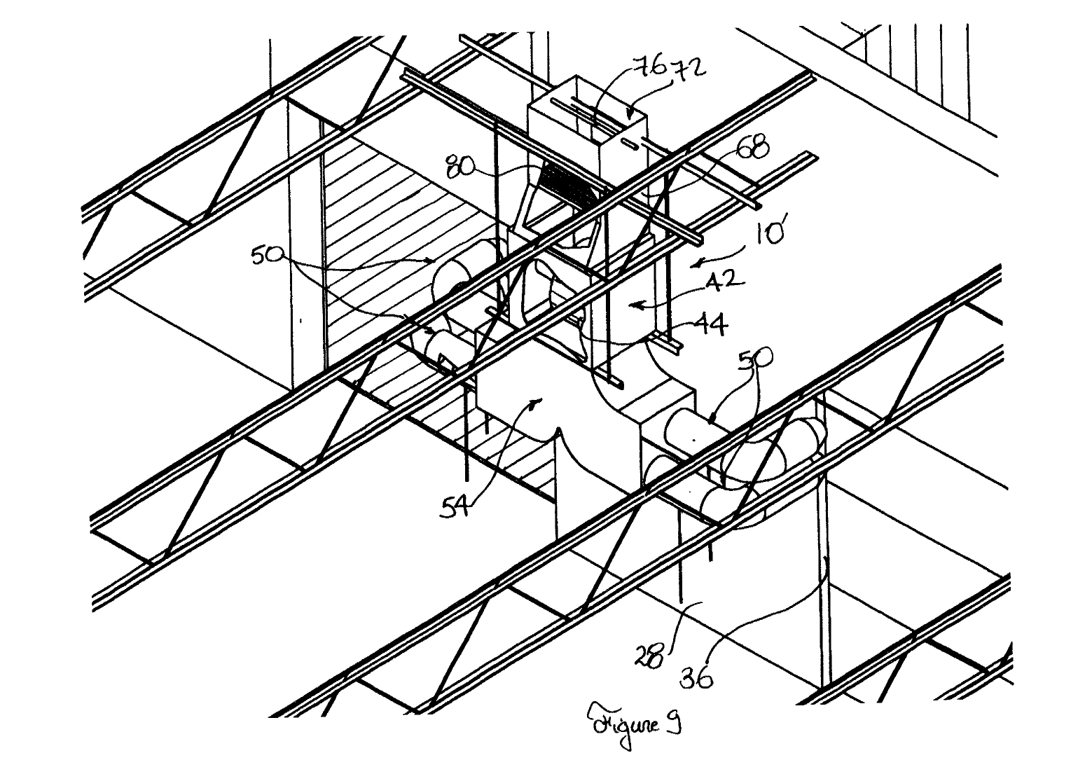

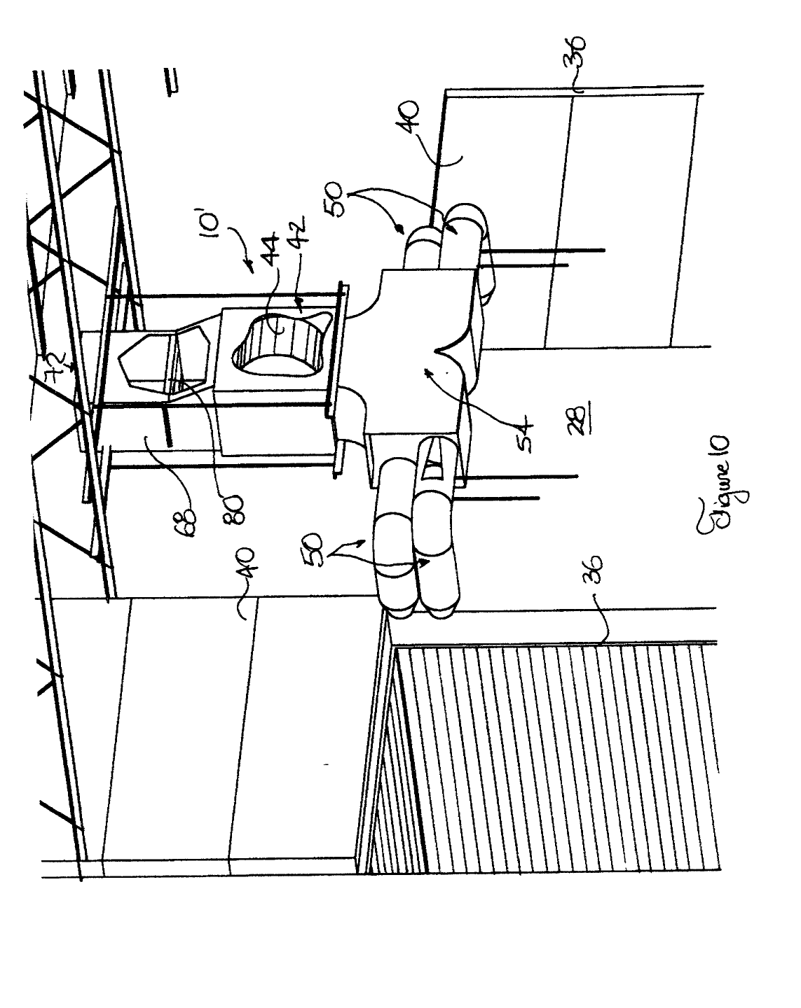

In an alternative embodiment of the invention illustrated in FIGS. 8 through 10, the ventilating system 10′ uses only one inlet duct 68′. The one inlet duct 68′ is configured, sized and positioned so that the corresponding inlet end 72′ is positioned adjacent the dock upper section. This alternative embodiment of the invention could prove to be particularly useful, for example, in situations wherein the ventilation system 10′ in the context of a refrigerated loading dock 14′ used with refrigerated vehicle compartments 12′. The ventilation system 10′ could be used for blowing the refrigerated ventilating air volume emanating from the refrigerated loading dock 14, into the vehicle compartment 12, thus reducing the need for maintaining the vehicle cooling system operational during docking of the vehicle to the loading dock.

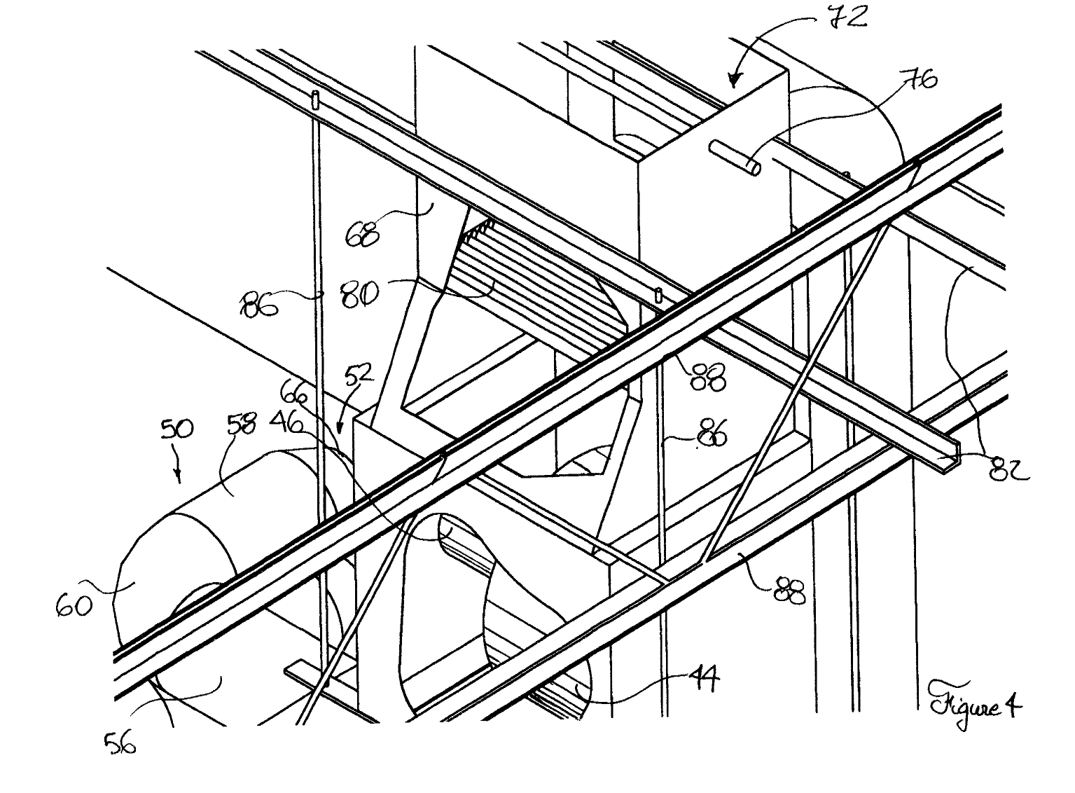

The ventilating system is optionally provided with an air filter for filtering the ventilating air volume. As illustrated more specifically in FIG. 4, the air filter typically takes the form of a filtering plate 80 inserted into at least one of the air inlet ducts 68, 70.

As shown more specifically in FIGS. 1 through 4, the ventilation system 10 is specifically designed so as to be easily mountable to conventional ceiling structures. The ventilation system 10 is optionally provided with a mounting frame including a first and a second pair of mounting studs 82, 84 maintained in spaced apart relationship relative to each other by spacing rods 86. The first pair of mounting studs 82 is adapted to be suspended to conventional ceiling frame studs 88 while the second pair of mounting studs 84 are adapted to abuttingly contact the lower surface of the blower component 42. It should be understood that other mounting structures could be used without departing from the scope of the present invention.

Typically although by no means exclusively, the outlet ducts 50 are made out of a suitable rigid material such as galvanized steel. Also, typically although by no means exclusively, the outlet ducts 50 have an inner diameter substantially in the range of 10″ while the nozzle 66 has an inner discharge diameter substantially in the range of 8″. Alternatively, the outlet ducts 50 could be made out of a deformable material or incorporate adjustment features such as a telescopic structure in order to allow for adjustment of the relative positioning between the discharge end 52 and the dock aperture 34.

The present invention also relates to a method for ventilating a vehicle storage compartment part of a vehicle docking at loading dock. The method comprises the step of drawing at least a fraction of the volume of loading dock air present in the loading dock area and blowing the drawn volume of air through the dock wall and through the vehicle rear opening so as to discharge the drawn volume of air into the vehicle storage compartment. Preferably, the drawn volume of air is discharged into the vehicle storage compartment as a jet of air aimed towards the vehicle front wall. The jet of air is calibrated so as to expel stagnant air from within the vehicle storage compartment.

The embodiments of the invention in which an exclusive privilege or property is claimed are defined as follows:

1. A loading dock vehicle ventilation system for ventilating a vehicle storage compartment part of a vehicle docking at loading dock, said vehicle storage compartment defining a vehicle platform, a pair of vehicle sidewalls extending from said vehicle platform, a vehicle front wall also extending from said vehicle platform and a vehicle rear opening positioned substantially opposite said vehicle front wall and leading into said vehicle storage compartment, said loading dock defining a dock platform having a docking edge, said loading dock also defining a dock ceiling and a dock wall extending from said dock platform adjacent said docking edge to said dock ceiling, said dock wall separating the interior environment of said loading dock from the exterior environment, said interior environment defining a dock upper section located substantially adjacent said dock ceiling and a dock lower section located substantially adjacent said dock platform, said dock wall being provided with a dock aperture extending therethrough, said dock aperture defining a pair of opposed dock aperture side peripheral edges and a dock aperture upper peripheral edge, the interior environment of said loading dock being filled with a volume of loading dock air, said ventilation system comprising:
a blower component defining a blower inlet and a blower outlet for drawing a ventilating air volume of said volume of loading dock air through said blower inlet and blowing said ventilating air volume through said blower outlet;
an outlet duct in fluid communication with said blower outlet, said outlet duct defining a discharge end, said outlet duct being configured, sized and positioned so that said discharge end is positioned adjacent said dock aperture allowing said discharge end to discharge said ventilating air volume though said dock aperture.

2. A ventilating system as recited in claim 1 wherein said outlet duct is configured, sized and positioned so that said discharge end is positioned inwardly relative to said dock wall and adjacent a corner portion of said dock aperture, said corner portion being defined by the interception of one of said dock aperture side peripheral edges with said dock aperture upper peripheral edge.

3. A ventilating system as recited in claim 1 wherein said discharge end is provided with a discharge nozzle for allowing said ventilating air volume to be discharged in the form of a ventilating jet of air projected out of said dock aperture.

4. A ventilating system as recited in claim 3 wherein said discharge nozzle has a generally frustro-conical configuration.

5. A ventilating system as recited in claim 1 wherein said outlet duct is provided with an outlet duct valve for regulating the flow of said ventilating air volume conveyed by said outlet duct.

6. A ventilating system as recited in claim 1 having a first outlet duct and a second outlet duct, said first and second outlet ducts being both in fluid communication with said blower outlet and respectively defining first and second outlet ends, said first and second outlet ducts being respectively configured, sized and positioned so that their respective first and second outlet ends are spaced in laterally opposite directions relative to said blower component; whereby said first and second outlet ends are adapted to discharge respectively through a first and a second dock aperture formed in said dock wall.

7. A ventilating system as recited in claim 6 wherein said first and second outlet ducts are respectively provided with first and second outlet duct valves for regulating the flow of said ventilating air volume conveyed respectively by said first and second outlet ducts.

8. A ventilating system as recited in claim 1 having a first pair of outlet ducts and a second pair of outlet ducts, said first and second pairs of outlet ducts being both in fluid communication with said blower outlet and respectively defining first and second pairs of outlet ends, said first and second pairs of outlet ducts being respectively configured, sized and positioned so that their respective first and second pairs of outlet ends are spaced in laterally opposite directions relative to said blower component, said ventilating system being further provided with a directing means mounted on said ventilating means for selectively directing the flow of said ventilating air volume either towards both outlet ends part of either one of said first or second pairs of outlet ends or towards a single outlet end part of both pairs of outlet ends; whereby said directing means allows for the discharge of said ventilating air volume either though a single one of said first or second dock apertures using two outlet ends or for the discharge of said ventilating air volume through both said first and second dock apertures using a single one of said outlet ends in each one of said first and second dock apertures.

9. A ventilating system as recited in claim 8 wherein said directing means includes an outlet valve mounted in each one of said outlet ends.

10. A ventilating system as recited in claim 1 further comprising an inlet duct in fluid communication with said blower inlet, said inlet duct defining an inlet end, said inlet duct being provided with an inlet valve for regulating the flow of said ventilating air volume conveyed by said inlet duct.

11. A ventilating system as recited in claim 10 wherein said inlet duct is configured, sized and positioned so that said inlet end is positioned adjacent said dock upper section.

12. A ventilating system as recited in claim 10 wherein said inlet duct is configured, sized and positioned so that said inlet end is positioned adjacent said dock lower section.

13. A ventilating system as recited in claim 10 wherein said inlet duct is provided with an air filter for filtering said ventilating air volume.

14. A ventilating system as recited in claim 1 further comprising a first inlet duct and a second inlet duct, said first and second inlet ducts being both in fluid communication with said blower inlet, said first and second inlet ducts respectively defining first and second inlet ends, said first and second inlet ducts being respectively provided with a first and a second inlet valve for regulating the flow of said ventilating air volume conveyed respectively by said first and second inlet ducts, said first inlet duct being configured, sized and positioned so that said first inlet end is positioned adjacent said dock upper section, said second inlet duct being configured, sized and positioned so that said second inlet end is positioned adjacent said dock lower section.

15. A ventilating system as recited in claim 6 wherein said ventilating system further includes a generally inverted “Y”-shaped splitting manifold in fluid communication with said blower outlet, said first and second outlet ducts both having substantially “L”-shaped configurations respectively defining a first and second outlet duct spacing segment extending laterally respectively from opposite sides of said splitting manifold and a first and second directing segment extending substantially perpendicularly from a corresponding first or second spacing segment in a direction leading substantially towards a corresponding one of said first or second dock apertures.

16. A method for ventilating a vehicle storage compartment part of a vehicle docking at loading dock, said vehicle storage compartment defining a vehicle platform, a pair of vehicle sidewalls extending from said vehicle platform, a vehicle front wall also extending from said vehicle platform and a vehicle rear opening positioned substantially opposite said vehicle front wall and leading into said vehicle storage compartment, said loading dock defining a dock platform having a docking edge and a dock wall extending from said dock platform adjacent said docking edge, said dock wall separating the interior environment of said loading dock from the exterior environment, said dock wall being provided with a dock aperture extending therethrough, the interior environment of said loading dock being filled with a volume of loading dock air, said method comprising the step of:
drawing a ventilating air volume of said volume of loading dock air and blowing said ventilating air volume through said dock wall and through said vehicle rear opening when said vehicle is docked at said loading dock so as to discharge said ventilating air volume into said vehicle storage compartment.

17. A method as recited in claim 16 wherein said ventilating air volume is discharged into said vehicle storage compartment as a jet of air aimed towards said vehicle front wall, said jet of air being calibrated so as to expel stagnant air from within said vehicle storage compartment.

18. In combination with a loading dock defining a dock platform having a docking edge, said loading dock also defining a dock ceiling and a dock wall extending from said dock platform adjacent said docking edge to said dock ceiling, said dock wall separating the interior environment of said loading dock from the exterior environment, said interior environment defining a dock upper section located substantially adjacent said dock ceiling and a dock lower section located substantially adjacent said dock platform, said dock wall being provided with a dock aperture extending therethrough, said dock aperture defining a pair of opposed dock aperture side peripheral edges and a dock aperture upper peripheral edge, the interior environment of said loading dock being filled with a volume of loading dock air, a loading dock vehicle ventilation system for ventilating a vehicle storage compartment part of a vehicle docking at loading dock, said vehicle storage compartment defining a vehicle platform, a pair of vehicle sidewalls extending from said vehicle platform, a vehicle front wall also extending from said vehicle platform and a vehicle rear opening positioned substantially opposite said vehicle front wall and leading into said vehicle storage compartment, said ventilating system comprising: a blower component defining a blower inlet and a blower outlet for drawing a ventilating air volume of said volume of loading dock air through said blower inlet and blowing said ventilating air volume through said blower outlet; an outlet duct in fluid communication with said blower outlet, said outlet duct defining a discharge end, said outlet duct being configured, sized and positioned so that said discharge end is positioned adjacent said dock aperture allowing said discharge end to discharge said ventilating air volume though said dock aperture.

19. A ventilating system as recited in claim 18 wherein said outlet duct is configured, sized and positioned so that said discharge end is positioned inwardly relative to said dock wall and adjacent a corner portion of said dock aperture, said corner portion being defined by the interception of one of said dock aperture side peripheral edges with said dock aperture upper peripheral edge; said discharge end being provided with a discharge nozzle for allowing said discharge nozzle to discharge said ventilating air volume into the form of a ventilating jet of air projected out of said dock aperture.

20. A ventilating system as recited in claim 18 having a first pair of outlet ducts and a second pair of outlet ducts, said first and second pairs of outlet ducts being both in fluid communication with said blower outlet and respectively defining first and second pairs of outlet ends, said first and second pairs of outlet ducts being respectively configured, sized and positioned so that their respective first and second pairs of outlet ends are spaced in laterally opposite directions relative to said blower component, said ventilating system being further provided with a directing means mounted on said ventilating means for selectively directing the flow of said ventilating air volume either towards both outlet ends part of either one of said first or second pairs of outlet ends or towards a single outlet end part of both pairs of outlet ends; whereby said directing means allows for the discharge of said ventilating air volume either though a single one of said first or second dock apertures using two outlet ends or for the discharge of said ventilating air volume through both said first and second dock apertures using a single one of said outlet ends in each one of said first and second dock apertures.
